(19) United States
(12) Patent Application Publication
(10) Pub. No.: US 2024/0119294 A1
(43) Pub. Date: Apr. 11, 2024

(54) DYNAMIC GRAPH REPRESENTATION LEARNING WITH SELF-SUPERVISION

(71) Applicants: Mhd Ali ALOMRANI, Brampton (CA); Mahdi BIPARVA, Toronto (CA); Yingxue ZHANG, Markham (CA)

(72) Inventors: Mhd Ali ALOMRANI, Brampton (CA); Mahdi BIPARVA, Toronto (CA); Yingxue ZHANG, Markham (CA)

(21) Appl. No.: 18/477,231

(22) Filed: Sep. 28, 2023

Related U.S. Application Data
(60) Provisional application No. 63/410,832, filed on Sep. 28, 2022.

(51) Int. Cl. G06N 3/0895

(52) U.S. Cl. CPC G06N 3/0895

(57) ABSTRACT

System, method, and computer readable medium for dynamic graph representation learning with self-supervision, including extracting a time window of data from the dynamic graph representation to obtain a history graph that represents a sub-set of the dynamic graph representation; generating, using an encoder model configured by a set of learned encoder parameters and implemented by the computer system, a set of embeddings for the history graph; and predicting, using a first decoder model configured by a first set of learned decoder parameters and implemented by the computer system, one or more predictions for the dynamic graph representation corresponding to the specific prediction task.

### RELATED APPLICATIONS

This application claims the benefit of and priority to U.S. Provisional Application No. 63/410,832, filed Sep. 28, 2022, the contents of which are incorporated herein by reference.

### FIELD

This disclosure relates to a system, methods and computer readable medium for dynamic graph representation learning with self-supervision.

### BACKGROUND

Given a Continuous-time Dynamic Graph (CTDG), the goal is to learn node embeddings that capture the structural and temporal evolution of each node such that the node embeddings can accurately be used for out-of-distribution detection or future event forecasting. There are 2 main tasks that are often explored in dynamic graphs.

(1) Future Link Prediction: Given access to all interactions before time t, what is the probability of having an edge between two nodes u and ν at time t? This is helpful in social networks that are intended to suggest to users interesting accounts or content. The edges to be predicted are known as target edges.

(2) Dynamic Node classification: Given access to all interactions before time t, predict the label of node u at time t; e.g., whether a user will get banned after some interactions.

Some known solutions to predicting target edges are based on the Random-Walk Approach. A random walk is a sequence of edges that form a connected path on a graph. For example, the edges (1,2) and (2, 3) form a walk of length 2 that connect nodes 1,2, and 3. For example, to predict a future edge (u,ν,t) given full history, the CaW method (Document 1: Yanbang Wang, Yen-Yu Chang, Yunyu Liu, Jure Leskovec, Pan Li. Inductive Representation Learning in Temporal Networks via Causal Anonymous Walks. International Conference on Learning Representations (ICLR), 202) relies on random-walk sampling to extract temporal patterns in a CTDG. N random walks of length L are sampled for both nodes u and ν. The CaW method uses feature engineering to extract temporal features from the walks that are aggregated by an attention module (Document 2: Ashish Vaswani, Noam Shazeer, Niki Parmar, Jakob Uszkoreit, Llion Jones, Aidan N. Gomez, Łukasz Kaiser, and Illia Polosukhin. Attention is all you need. International Conference on Neural Information Processing Systems (NIPS '17)). The output of the attention-module is fed to a Multi-layer perception (MLP) decoder that is trained to classify the edge (u,ν,t) as a positive edge.

Memory-based methods rely on a RNN module that learns to compress the full history of interactions with a node into a single memory representation. Recurrent neural networks (RNNs) are a class of MLPs that are helpful in modeling sequential data. RNNs are typically used in tasks that involve predicting the future given the past; e.g. predict next word in a sentence given past words. The memory representation holds enough information about a node's past such that there is no need to explicitly store all past interactions to predict the future. That is, to predict future edge (u,ν,t), the memory representations of nodes u and ν are fed to a MLP decoder that is trained to classify the edge (u,ν,t) as a positive edge.

Another solution, temporal graph attention (TGAT), is based on temporal message passing. To predict a future edge (u,ν,t), TGAT first generates the embeddings of u and ν through recursive graph neural network (GNN)-like message passing through time. That is, the embedding of each node is learned by iteratively combining the embedding of the node itself with the embeddings of local historical neighborhood. The node embeddings are fed into an MLP decoder is trained to classify the edge (u,ν,t) as a positive edge.

Known solutions can suffer from one or more of the following issues.

Hyperparameter Sensitivity: State-of-the-art methods such as CaW rely on expensive random walk sampling that is controlled by hyperparameters such as number of walks to be samples and length of the walks. Such hyperparameters can significantly affect the performance and, hence, must be carefully tuned. Finding the right parameters is costly for large CTDGs.

Full History: Known solutions are trained to predict future interactions while having access to full history of previous interactions which is unscalable for online learning i.e. memory and computation increases as new interactions arrive.

No Forecasting: Known solutions are trained to predict the next immediate incoming edge only (i.e., predict edge (u,ν,t) given access to all previous interactions before time t) . Therefore, prior solutions cannot reliably forecast far into the future by predicting at once the next K interactions.

Pre-training Incompatibility: Known solutions can only generate node embeddings given the target edges to predict i.e. cannot generate task-agnostic embeddings. Therefore, such methods are not compatible with the self-supervised learning (SSL) paradigm which aims to pre-train a GNN to learn generic node embeddings.

Recursive Message-passing: Message passing methods such as TGAT perform recursive message passing through time for each target edge.

Therefore, a separate message-passing operation must be performed for each target edge to generate node embeddings. This can be costly as the number of target edges increases.

Accordingly, there is a need for an improved system, method, and computer-readable medium for CTDG processing.

### SUMMARY

According to a first example aspect, a method is disclosed for operating a computer system to process a continuous-time dynamic graph (CTDG) to perform a specific prediction task, the CTDG comprising a data structure that represents nodes and edges having temporal properties, the edges representing relationships between the nodes. The method comprises: extracting a time window of data from the CTDG to obtain a history graph that represents a sub-set of the CTDG; generating, using an encoder model configured by a set of learned encoder parameters and implemented by the computer system, a set of embeddings for the history graph; and predicting, using a first decoder model configured by a first set of learned decoder parameters and implemented by the computer system, one or more predictions for the CTDG corresponding to the specific prediction task.

According to an example of the first aspect, the method comprises configuring the computer system to perform the specific prediction task. This includes pre-training the encoder model using self-supervised learning to perform a generalized prediction task by: partitioning the CTDG into a first batch of first disjoint graphs that each correspond to a respective time window of a first defined size; performing a random transformation on each of the first disjoint graphs to generate, for each first disjoint graph, a respective pair of transformed graphs; and iteratively, until a pre-training criteria is reached: (i) generating, using the encoder model, respective embeddings for each transformed graph in each pair of transformed graphs; (ii) generating, for each of the respective embeddings, a respective prediction, using a second decoder model that is configured by a set of second decoder parameters; and (iii) updating the encoder parameters and the second decoder parameters based on the respective predictions. Furthermore, the encoder model and the first decoder model are trained to collectively perform the specific prediction task by: partitioning the CTDG into a second batch of second disjoint graphs that each correspond to a respective time window of a second defined size; and iteratively, until a training criteria is reached: (i) generating, using the encoder model, respective embeddings for each of the second disjoint graphs; (ii) generating, for each of the respective embeddings of the second disjoint graphs, a respective task specific prediction, using the first decoder model; and (iii) updating at the first decoder parameters based on a comparison of the respective task prediction to actual data included in the CTDG.

According to one or more of the preceding examples, during the pre-training, updating the encoder parameters and the second decoder parameters based on the respective predictions comprises comparing, for each pair of transformed graphs, the respective predictions made therefore.

According to one or more of the preceding examples, during training the encoder model and the first decoder model to collectively perform the specific prediction task, the encoder parameters are frozen and only the first decoder parameters are updated.

According to one or more of the preceding examples, the first defined size and the second defined size are hyperparameters.

According to one or more of the preceding examples, performing the random transformation on each of the first disjoint graphs comprises randomly performing edge dropouts and edge feature masking.

According to one or more of the preceding examples, the encoder model is an attention-based Message-Passing (AMP) neural network.

According to one or more of the preceding examples, the first decoder model and second decoder model comprise respective multi-layer perception neural networks.

According to one or more of the preceding examples, the specific prediction task is predicting a probability of an edge between two nodes of the CTDG at a future time, the method comprising outputting the prediction.

According to one or more of the preceding examples, the specific prediction task is predicting node classifications for one or more nodes of the CTDG at a future time, the method comprising outputting the predicted node classifications.

According to a further example aspect, a computer system is disclosed that is configured to perform the method of one or more of the preceding aspects.

According to a further example aspect, a computer program product is disclosed that stores non-transient instructions that configure a computer system to perform the method of one or more of the preceding aspects.

### BRIEF DESCRIPTION OF THE DRAWINGS

Reference will now be made, by way of example, to the accompanying drawings which show example embodiments of the present application, and in which:

FIG. 1 is a block schematic diagram illustrating windows-based dynamic graph encoding, according to example implementations.

FIG. 2 is a block schematic diagram illustrating non-contrastive self-supervised learning for dynamic graph learning, according to example implementations.

FIG. 3 is a block diagram of a processing unit on which one or more modules of the present disclosure may be implemented.

FIG. 4 is a block schematic diagram illustrating windows-based dynamic graph encoding, according to further example implementations.

Similar reference numerals may have been used in different figures to denote similar components.

### DESCRIPTION OF EXAMPLE EMBODIMENTS

Graphs are general data structures that model complex relations between real-world objects. A static graph is comprised of a set of nodes and edges. Nodes represent objects (e.g. atoms) while edges represent a relation between 2 objects (e.g. chemical bond). Graphs are often used to model many complex real-world systems such as molecules, social networks, transaction systems, etc. Many such applications of graphs are dynamic and evolve over time (e.g. recommendation systems). A continuous-time dynamic graph (CTDG) defines a sequence of asynchronous continuous-timed interactions between nodes. An interaction is an edge that forms between old or newly arriving nodes. The temporal aspect of dynamic graphs conveys rich information that can be learned to predict future interactions (e.g. predict future transactions given a history).

Graph Neural Networks (GNNs) are neural network models that learn to encode the structural information of a graph into vector representations for each node i.e. node embeddings. GNNs output node embeddings that capture the topological structure of each node's neighborhood through a series of neighborhood aggregation layers. Neighborhood aggregation updates the embedding of a node through 2 steps. First, the embeddings of its local neighborhood nodes are aggregated via an aggregation function (e.g. Multi-layer perceptron (MLP) network) to output a neighborhood vector. The aggregated neighborhood vector is then combined with the node's embedding to produce the new embedding.

The local neighborhood of a node means the direct connection of that node in the given topology (graph). For example, the followers of a user in a social network. A multi-layer perception (MLP) neural network transforms the input using a learnable non-linear transformation function to learn weights on every single dimension of the input vector. The output of MLP neural network is the input vector weighted by neural network parameters, and the neural network parameters will be updated via gradient descent.

Self-supervised learning is a paradigm that involves learning from data with no human-provided labels. Unlike supervised learning, where a model (e.g. GNN) is trained to output the same labels for similar inputs (e.g. node embeddings), SSL uses the data itself to supervise learning the GNN. That is, SSL methods leverage domain knowledge to learn representations suitable for any downstream tasks. In example implementations, a GNN is pre-trained based on a self-supervision paradigm to learn rich node embeddings. The pre-trained GNN learn generic node embeddings that are used for any unknown downstream tasks defined on the data domain. The downstream tasks can benefit from fine-tuning the learned node embeddings for any given objective rather than training from scratch (i.e. starting from randomly initialized node embeddings).

As used here, a “module” and a “unit” can refer to a combination of a hardware processing circuit and machine-readable instructions and data (software and/or firmware) executable on the hardware processing circuit. A hardware processing circuit can include any or some combination of a microprocessor, a core of a multi-core microprocessor, a microcontroller, a programmable integrated circuit, a programmable gate array, a digital signal processor, or another hardware processing circuit.

The present disclosure is directed to a continuous-time dynamic graph (CTDG) processing system that is directed to resolving one or more of the following problems: (1) Window-based History: In at least some examples, the disclosed system does not require access to full history of interactions to predict any future edge. The disclosed system provides a mechanism to control information bottleneck based on the data domain dynamic properties. (2) Forecasting: In at least some examples, the disclosed system can reliably predict interactions far into the future. (3) SSL Pre-training: In at least some examples, the disclosed system can benefit from SSL methods.(4) Task-agnostic Embeddings: In at least some examples, an encoder of the disclosed system performs GNN-like message passing for all nodes exactly once to produce task-agnostic embeddings that can be used to predict any target edge.

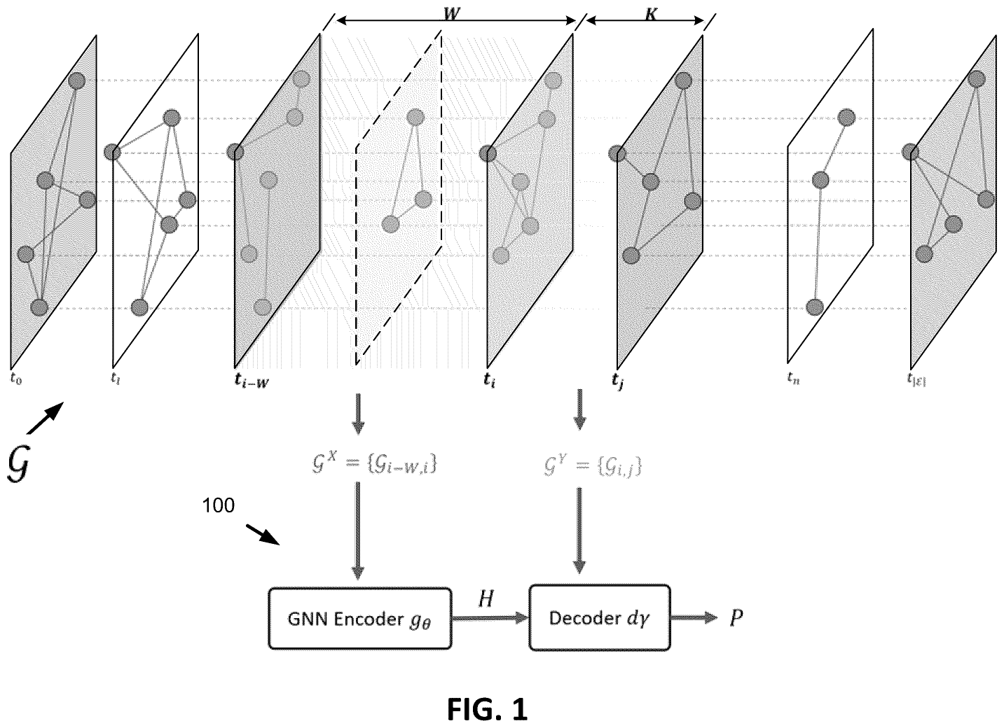

FIG. 1 is a block diagram illustrating operation of a system 100 for windows-based dynamic graph encoding in respect of an input CTDG , according to example implementations. As described in greater detail below, features of some examples of the disclosed system 100 can include the following. (1) Window-based History: To predict any future interactions, in at least some examples, the disclosed system relies on a fixed history window of size W (i.e. to predict edge (u,ν,t), the system only uses the last W interactions before time t). Window-based Dynamic Graph Encoding allows for constant memory and computation. (2) Encoder-Decoder Architecture: in at least some examples, the disclosed system is composed of independent encoder g_{θ} and decoder d_{γ} modules. The encoder g_{θ} produces task-agnostic node embeddings. The decoder d_{γ} outputs a task dependent prediction given the node embeddings. (3) SSL Pre-Training: The encoder g_{θ} is compatible with any suitable SSL method by design. Therefore, the encoder g_{θ} can be pre-trained separately from the decoder d_{γ}. The full model (e.g. encoder g_{θ} and decoder d_{γ}) can be further fine-tuned on any task.

In at least some examples, the disclosed system 100 is applicable for modeling problems that can be regarded as dynamic graph problems. For example, the system 100 can be applied to view social networks as a dynamic graph where at each continued time point, two people will send a message or follow each other which forms a new edge of two nodes. The downstream task could be predicting future interactions (send messages, following or re-post) between two people. Another recommender system application is where the user-item interaction can form a (dynamic) bipartite graph. The edge between users and items includes interaction such as download, click, purchase and etc. The downstream tasks could be predicting the future interaction between users and items.

Encoder-Decoder Architecture: An Encoder decoder paradiam for the disclosed system is as follows.

Given any CTDG, the encoder g_{θ} outputs node embeddings that capture the temporal patterns of each node. The node embeddings are task-agnostic, i.e. the same node embeddings are produced regardless of task or the edges to predict. The decoder d_{γ} is responsible for output task-specific predictions (e.g. edge probabilities) given the node embeddings:

H=g_{θ}( [symbol] )
=d_{γ}(H)
Where:
g_{θ}: Encoder model parameterized by θ
d_{γ}: Decoder model parameterized by γ
H: Output Node Embeddings
Z: Task-specific prediction e.g. Edge probabilities
[symbol] : Input Dynamic Graph

Here, θ and γ represent the trainable parameters of the encoder g_{θ} and decoder d_{γ} respectively. Note that, unlike previous approaches which generate different node embeddings for each edge to be predicted, the same set of node embeddings are used for all predictions, i.e. all future edges to be predicted. Moreover, the message passing is performed in a flat manner, i.e. no recursive temporal message passing for each target as in TGAT. This allows the encoder g_{θ} to aggregate messages coming through other nodes without needing to recompute for each target edge.

Window-based Dynamic Graph Encoding: The disclosed system 100 incorporates windows-based dynamic graph encoding, as represented in FIG. 1. Consider a CTDG [symbol] that contains edges from time t₀ to final time t_{|E|} where |E| is the total number of edges in g. The training and inference stages of the system 100 to learn any downstream task are described below:

Inference: Let [symbol] ^{Y}=(V^{Y}, E^{Y}) be the target graph where E^{Y} is the set of target edges (e.g. future edges to predict) and V^{Y} be the set of nodes involved in the target edges. The model (e.g., system 100) is tasked to make a prediction on a set of K future edges (E^{Y}) from time tᵢ to tⱼ given the history graph [symbol] ^{X} that only contains the past W edges from time t_{i-W} to tᵢ.

The encoder g e GNN performs message passing on [symbol] ^{X} to generate node embeddings H i.e. H=g₇₄ ( [symbol] ^{X}). H contains node embeddings of all nodes in V^{Y}.

Given H, the decoder d y outputs a set of predictions P for all target edges in E^{Y}. While the encoder g_{θ} architecture is universal, the design of the decoder d_{γ} and what it predicts is task-specific. For example, for future link prediction, the decoder d_{γ} is a MLP predicts the probability of each future edge (u,ν,t) ∈ E^{Y} given the embeddings of u, ν and target time t.

Training: The full CTDG [symbol] is partitioned into a set of disjoint graphs of size K: { [symbol] _{i,i+K}|i ∈ {0, K, 2 K, . . . , |E|−K}}. Each graph [symbol] _{i,i+K} is considered to be a target graph [symbol] ^{Y}; the model is trained to make correct predictions on [symbol] ^{Y} given a window of history [symbol] ^{X}= [symbol] _{i-W, i}. Both the encoder and decoder's weights are optimized using backpropagation in order to make accurate predictions about each target graph [symbol] _{i,i+K} given its past.

Both K and W are hyperparameters that control how far the model is predicting into the future and how far it is looking in the past, respectively.

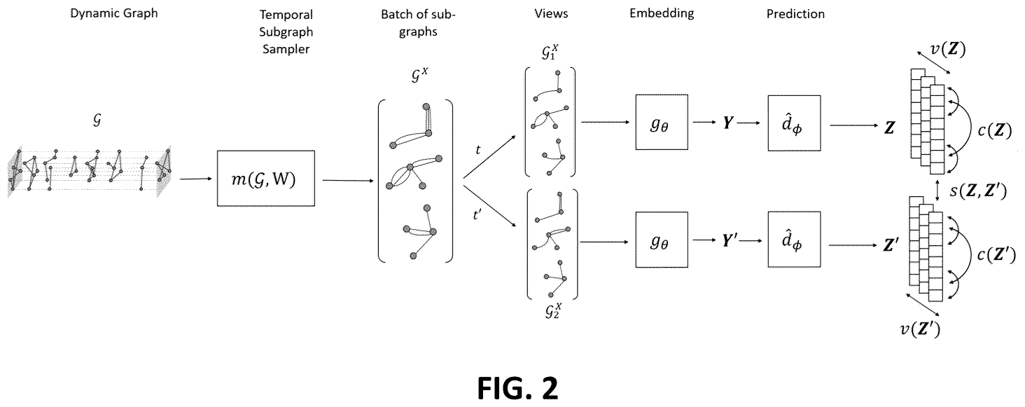

SSL Pre-Training: With reference to FIG. 2, according to example embodiments, the system 100 applies non-contrastive self-supervised learning for dynamic graph learning.

Instead of directly training the model on the downstream task (e.g. future link prediction), the disclosed system 100 adopts a two-stage training approach in which the encoder g e is pre-trained on a self-supervised task to generate generic node embeddings.

Pre-training Stage: The full CTDG [symbol] is partitioned by the temporal subgraph sampler m into a batch of disjoint graphs of size W: m( [symbol] ,W)={ [symbol] _{i,i+W}|i ∈ {0, W, 2 W, . . . , |E|−W}}. For each disjoint graph [symbol] ^{X}= [symbol] _{i,i+W}, the temporal distortion module generates two graphs [symbol] ₁^{X}=t( [symbol] ^{X}) and [symbol] ₁^{X}=t′( [symbol] ^{X}) (known as views of [symbol] ^{X}) where t and t′ are random transformation functions. A random transformation function is a function that randomly distorts a graph (e.g. randomly removes edges/nodes). The 2 views are then encoded using g_{θ} to generate node embeddings Y and Y′. A MLP decoder \hat{d}₉₉ maps the node embeddings to Z and Z′ respectively. Lastly, the parameters ϕ and θ are optimized to minimize the Variance-Invariance-Covariance Regularization (VICReg) SSL loss [symbol] _{SSL} using backpropagation:

[symbol]

_{SSL}=μ[c(Z)+c(Z′)]+α[ν(Z)+ν(Z′)]+πs(Z, Z′)

Where μ, α, π are hyper-parameters that control the importance of each term in the loss. It is noteworthy that the disclosed system is compatible with any non-contrastive SSL method and not just VICReg. (Non-contrastive SSL methods are a class of SSL algorithms that do not involve sampling negative views. Negative views are views that do not come from the same source and, hence, must be pushed apart i.e. node embeddings in difference views must be dis-similar.) VICReg SSL loss is described in Document 3: Adrien Bardes, Jean Ponce, and Yann LeCun. VICReg: Variance-Invariance-Covariance Regularization for Self-Supervised Learning. International Conference on Learning Representations (ICLR '22).

Downstream Stage: Once the encoder g_{θ} is pre-trained, it can be used along with a task-specific decoder d_{γ} to learn any downstream task as described above (e.g., see training and inference sections above as described in respect of windows-based dynamic graph encoding. In example implementations, decoder d_{γ} is learned from scratch and is different from the SS decoder \hat{d}₉₉ which is only used in the pre-training stage. The encoder's parameters θ can be further fine-tuned (refined) along with the decoder's parameters γ on the downstream task. To speed up learning, the pre-trained encoder's parameters θ can be frozen (i.e. not optimized) and only the task-specific decoder is trained.

By way of summary overview, features of the disclosed CTDG processing system (also referred to as a dynamic graph representation learning with self-supervision system) can include:

Window-based Framework: Using a window of history to predict the future gives a natural bias towards recent interactions which often have large influence on future interactions. Using a fixed window has significant memory and speed advantages as only the past W edges need to be stored and encoded to predict future interactions.

Encoder is pre-trained to generate generic but rich embeddings on different windows of the graph: This allows the encoder to learn the fine-grained temporal motifs that often exist in CTDGs. A temporal motif is a law found in a CTDG that reflects how the graph evolves over time. For example, the law of triadic closure states that 2 nodes that share a common neighbor in the past tend to be connected in the future.

Pre-training can significantly boost downstream training. An already pre-trained encoder g e converges faster as it has already learned rich node embeddings in the pre-training stage. Pre-training is particularly useful in low-label regime where there are very little downstream task labels to train on. SSL pre- training can help leverage both labeled and un-labeled data to learn useful embeddings.

Task-agnostic Encoder Architecture: Given an input CTDG, the encoder g e generates node embeddings regardless of the task or prediction i.e. the same set of node embeddings is used to make all future predictions. Given the node embeddings, the decoder d y is trained to make a prediction on the next K future edges rather the next immediate edge only. Thus, embeddings do not need to be recalculated for every prediction and the system 100 is able to forecast far into the future, which is useful for planning ahead in real-world systems.

Further, the disclosed system does not require recursive message passing through time for each target edge. Messages are only computed and aggregated once for all nodes. This can result in better efficiency and memory usage as message passing is only done once to compute all node embeddings.

The disclosed solution is suitable for any kind of real-world system that can be modeled as a CTDG, e.g. recommendation systems, transaction networks, social networks, etc. An example of a concrete use case would be malicious detection in social networks. In a social network, the nodes represent users while the edges represent interactions (e.g. tweets, likes, etc.). The social network is dynamically evolving as new users join or existing users interact with the platform; therefore, it can be considered a CTDG.

Social networks often have many malicious users or bots that must be detected in a timely manner to avoid societal harm. This problem can be thought of as a dynamic node classification task where, given the past interactions, we would like to predict the label of a node; e.g., whether a user should get banned or not after some interactions.

For this specific task, scarce training labels presents a challenge since all the labels must be manually tagged by annotators. The disclosed system can help solve this problem by leveraging SSL pre-training to learn from both labelled and unlabeled data. The window-based approach can help improve accuracy as recent interactions are often highly indicative of malicious behavior.

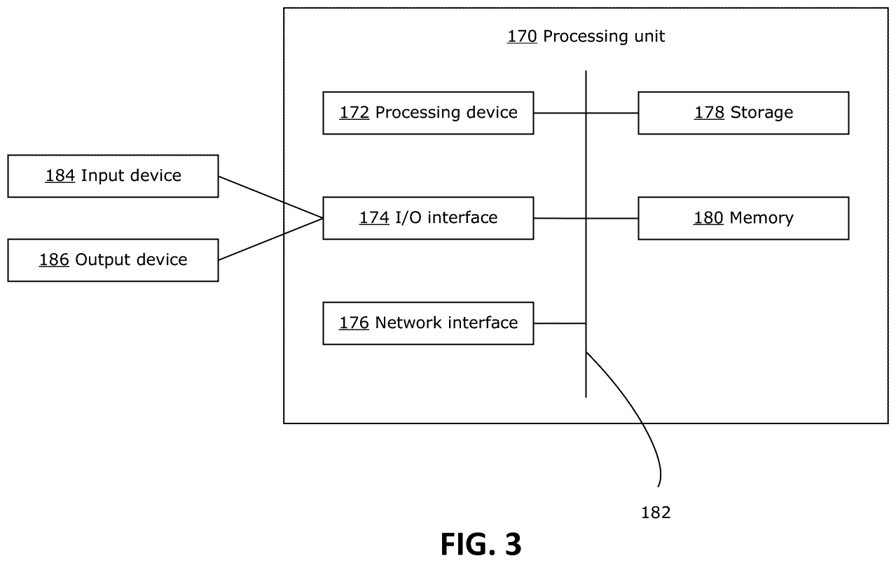

FIG. 3 is a block diagram of an example processing unit 170, which may be used to implement one or more of the modules or units of system 100, including the configurations of FIGS. 1, 2 and 4 (described below). Processing unit 170 may be used in a computer device to execute machine executable instructions that implement one or more of the modules or parts of the modules of system 100. Other processing units suitable for implementing embodiments described in the present disclosure may be used, which may include components different from those discussed below.

The processing unit 170 may include one or more processing devices 172, such as a processor, a microprocessor, a general processor unit (GPU), a hardware accelerator, an application-specific integrated circuit (ASIC), a field-programmable gate array (FPGA), a dedicated logic circuitry, or combinations thereof. The processing unit 170 may also include one or more input/output (I/O) interfaces 174, which may enable interfacing with one or more appropriate input devices 184 and/or output devices 186. The processing unit 170 may include one or more network interfaces 176 for wired or wireless communication with a network (e.g with networks 118 or 132).

The processing unit 170 may also include one or more storage units 178, which may include a mass storage unit such as a solid state drive, a hard disk drive, a magnetic disk drive and/or an optical disk drive. The processing unit 170 may include one or more memories 180, which may include a volatile or non-volatile memory (e.g., a flash memory, a random access memory (RAM), and/or a read-only memory (ROM)). The memory(ies) 180 may store instructions for execution by the processing device(s) 172, such as to carry out examples described in the present disclosure. The memory(ies) 180 may include other software instructions, such as for implementing an operating system and other applications/functions.

There may be a bus 182 providing communication among components of the processing unit 170, including the processing device(s) 172, I/O interface(s) 174, network interface(s) 176, storage unit(s) 178 and/or memory(ies) 180. The bus 182 may be any suitable bus architecture including, for example, a memory bus, a peripheral bus or a video bus.

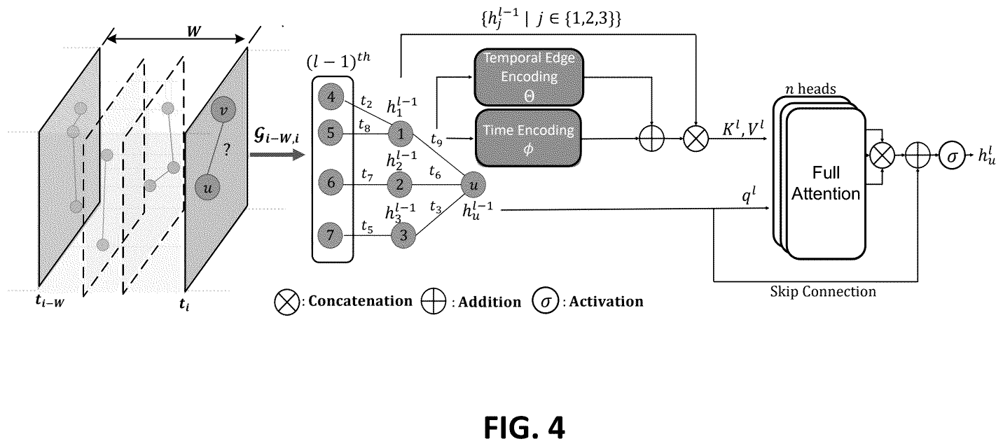

A further example implementation is shown in FIG. 4.

In the example of FIG. 4, a Continuous-Time Dynamic Graph (CTDG) [symbol] =( [symbol] , [symbol] χ) is a sequence of E=|ε| interactions, where χ=(X^{V}, X^{E}) is the set of input features containing the node features X^{V} ∈ [symbol] ^{N×D}^{^{V}} and the edge features X^{V} ∈ [symbol] ^{E×D}^{^{E}}. ε={e₁, e₂, . . . , e_{E}} is the set of interactions. There are N=| [symbol] | nodes, and D^{V} and D^{E} are the dimensions of the node and edge feature vectors, respectively. An edge eᵢ=(uᵢ, νᵢ, tᵢ, mᵢ) is an interaction between any two nodes uᵢ, νᵢ ∈ [symbol] ᵢ with tᵢ ∈ [symbol] R being a continuous timestamp, and mᵢ ∈ X^{E} an edge feature vector. For simplicity, the present description assumes that the edges are undirected and ordered by time (i.e., tᵢ≤tᵢ₊₁). A temporal sub-graph Gi, is defined as a set consisting of all the edges in the interval [, tⱼ], such that εᵢⱼ={eₖ|tᵢ≤tₖ<tⱼ}. Any two nodes can interact multiple times throughout the time horizon; therefore, [symbol] is a multi-graph. Training is applied to learn a model f that maps the input graph to a representation space. The model is a pre-trainable encoder-decoder architecture, f=(g_{θ}, d_{γ}). The encoder go maps a dynamic graph to node embeddings H^{V} ∈ [symbol] ^{N×D}^{^{H}}; the decoder d_{γ} performs a task specific prediction given the embeddings. The model f is parameterized by the encoder/decoder parameters (θ,). More concretely, H=( [symbol] ), Z=(H;ē), where z ∈ R^{D}^{^{Y}} is the prediction of task-specific labels (e.g., edge prediction or source node classification labels) of the target (future) edge ē. The node embeddings H capture the temporal and structural dynamics of each node such that the future can be accurately predicted from the past, e.g., future edge prediction given past edges. The main distinction of this design is that, unlike previous dynamic graph models, the encoder produces embeddings independent of the downstream task specifications.

The disclosed solution can learn node embeddings at any timestamp t independent of the downstream task, using a two-stage framework. In the first stage, a non-contrastive SSL method is used to learn the model f^{SSL}=(g_{θ}, d_{ψ}) over various sampled dynamic sub-graphs with self-supervision. d_{ψ} is an SSL decoder that is only used in the SSL pre-training stage. In the second stage, a task-specific decoder d_{γ} is trained on top of the pre-trained encoder g_{θ} to compute the outputs for the downstream tasks, e.g., future edge prediction or dynamic node classification. As in the above described example implementation, two example downstream tasks are considered: future link prediction (FLP), and dynamic node classification (DNC). In each task, a prediction is made on a set of target (positive) edges. For FLP, this is augmented by a set of negative edges ε̅. Each negative edge (uⱼ, ν′ⱼ, tⱼ, mⱼ) differs from its corresponding positive edge ε only in the destination node, ν′ⱼ≠νⱼ, which is selected at random from all nodes. The FLP task is then binary classification for the test set of 2 |ε̅| edges. In the DNC task, a dynamic label is associated with each node that participates in an interaction. The source node and interaction time {(uⱼ, tⱼ)}, are provided. The goal is to predict the source node labels for the test interactions. Each prediction is given only access to the past, i.e., edges before time tⱼ.

The example of FIG. 4 will be described in the same manner as the previous example: the encoder architecture will be described, followed by a description of a window-based downstream training approach, followed by description of an SSL pre-training approach with a non-contrastive loss function for dynamic graphs.

Encoding Model

The encoder of the example of FIG. 4 also combines a self-attention mechanism for message passing with a learnable time-encoding module that provides relative time encoding. Temporal edge encoding is applied that captures the temporal structural relationship between nodes.

Temporal Attention Embedding:

Given a dynamic graph [symbol] , the encoder g_{θ} computes the embedding hᵢ^{L} ∈ [symbol] ^{D}^{^{H}} of node i through a series of L multi-head attention (MHA) layers that aggregate messages from its L-hop neighborhood.

Given a node embedding hᵢ^{l-1} at layer l−1, N 1-hop neighborhood interactions of node i are uniformly sampled, [symbol] (i)={eₚ, . . . , eₖ}⊆ϵ. The embedding hᵢ^{l} at layer l is calculated by:

hᵢ^{l}=W₁hᵢ^{l-1}+MHA^{l}(q^{l}, K^{l}, V^{l})

q^{l}=hᵢ^{l-1},

K^{l}=V^{l}=[Φₚ(tₚ, . . . , Φₖ(tₖ)].

Here, W₁ is a learnable mapping matrix, MHA^{l}(·) is a multi-head dot-product attention layer, and Φₚ(tₚ) represents the edge feature vector of edge eₚ=(uₚ, νₚ, tₚ, mₚ)∈ [symbol] (i) at time tₚ:

Φₚ(tₚ)=[hᵤ_{ₚ}^{l-1}∥fₚ(tₚ)∥mₚ],

fₚ(tₚ)=ϕ(tᵢ−tₚ)+Θₚ(tₚ),

tᵢ=max{tₗ|eₗ∈ [symbol] (i)},

where ∥ denotes concatenation and ϕ(t)=[cosω₁t, . . . ,cosω_{DH}t] is a learnable Time2Vec module that helps the model be aware of the relative timespan between a sampled interaction and the most recent interaction of node i in the input graph. Θ(.) is a temporal edge encoding function, described in more detail below. In contrast to TGAT's recursive message passing procedure, the message passing in the present encoder is ‘flat’: at every iteration, the same set of node embeddings is used to propagate messages to neighbors. That is, messages are not restricted to flow towards the source node only but rather treat the sampled temporal graph as undirected. This allows the encoder to better capture the multi-hop common neighbors between the target nodes, which are vital to learning the temporal motifs and predicting future interactions. Additionally, neighbor sampling is not restricted to go backwards in time (i.e. causal sampling). Lastly, the relative time encoding is with respect to the latest timestamp, t i , incident to the source and not with respect to the target edge timestamp; hence, allowing the encoding step to be independent of the prediction (decoding) step and making the generated embeddings task-agnostic.

Temporal Edge Encoding:

Dynamic graphs often follow evolutionary patterns that reflect how nodes interact over time. For example, in social networks, two people who share many friends are likely to interact in the future. Therefore, two simple yet effective temporal encoding methods are incorporated in the present encoder that provide inductive biases to capture common structural and temporal evolutionary behaviour of dynamic graphs. The temporal edge encoding function is then:

Θp(tₚ)=W₂[zₚ(tₚ)∥cₚ(tₚ)], incorporating: (i) Temporal Degree Centrality zₚ(tₚ) ∈ [symbol] : the concatenated current degrees of nodes uₚ and νₚ at time tₚ; and (ii) Common Neighbors cₚ(tₚ) ∈ [symbol] : the number of common 1-hop neighbors between nodes up and νₚ at time tₚ. By using the degree centrality as an edge feature, the model is able to learn any bias towards more frequent interactions with high-degree nodes. The number of common neighbors helps capture temporal motifs, and it is known to often have a strong positive correlation with the likelihood of a future interaction.

Downstream Training

In the downstream training stage, the model f=(g_{θ}, d_{ψ}) includes the encoder go and a task-specific decoder d_{ψ} which is trained using a similar window-based training strategy. The model is trained to make predictions depending on the downstream tasks (e.g., link prediction or node classification). It will be appreciated that all tasks considered for dynamic graphs involve predicting a (future) target edge given access to the past interactions. However, rather than having access to all past edges, in the present example, the model is limited to a fixed window of W interactions. That is, to predict a target edge ē=(uⱼ, νⱼ, tⱼ, mⱼ), an input (history) graph [symbol] ⱼ−w_{,j} is sampled from the time interval {t_{j-W}, tⱼ}, centered at uⱼ and νⱼ, and a prediction is made as follows: H=g₀(G_{j-W,j}) is the matrix of node embeddings returned by the encoder, and z=d_{ψ}(H; e) is the prediction output of the decoder. The model parameters are optimized by training with a loss function [symbol] (z, o), where [symbol] _{D} is defined depending on the downstream task and o contains task-specific labels. As the embeddings of uⱼ and vⱼ are generated through message passing on the same sampled graph, the encoder can better recognize similar historical patterns between the target nodes without the need for costly motif-correlation through counting that is performed in walk-based methods.

The window-based training strategy can provide a number of advantages. First, the window acts as a regularizer by providing a natural inductive bias towards recent edges, which are often more predictive of the immediate future. Second, it avoids costly time-based neighborhood sampling. Third, relying on a fixed windowsize for message-passing allows for constant memory and computational complexity, which is well-suited to the practical online streaming data scenario.

Self-supervised Pre-training for Dynamic Graphs

It has been shown that temporal motifs can develop at different timescales throughout a dynamic graph. For example, question-answer patterns on

StackOverflow typically take 30 minutes to develop while messaging patterns on social media platforms can take less than 20 minutes to form. Accordingly, in example implementations, a window-based pre-training strategy is applied where the encoder is trained on a sliding window of the dynamic graph in an effort to learn the fine-grained temporal patterns throughout the time horizon. Given the full input dynamic graph [symbol] _{0, E}, a set of intervals I is generated by dividing the entire time-span {t₀, t_{E}} into M=┌E/S┐−1 intervals with stride S and interval length W. Let B⊂I be a mini-batch (randomly sampled subset) of intervals. Given B, the sub-graph sampler ( [symbol] ,;) constructs the mini-batch of input graphs: Ĝ={ [symbol] _{i,j}|[i, j)∈B}. In principle, [symbol] , ϵ G is an input graph to the SSL pre-training. The parameter W controls the size of the window while S controls the stride between intervals. In an illustrative example, setting S=200 and W=32 K was found to give a reasonable trade-off to learn both the long-range and short-range patterns within the dynamic graph. A joint-embedding can be applied which two views of a mini-batch of sub-graphs are generated through random transformations. The transformations are randomly sampled from a distribution defined by a distortion pipeline. The encoder maps the views to node embeddings which are processed by the encoder to generate node representations. An SSL objective (described below) is minimized to optimize the model parameters end-to-end in the pre-training stage.

The temporal distortion module generates two views of the input graphs:

[symbol]

′=t′( [symbol] ) and [symbol] ″=t″( [symbol] )

where the transformations t′ and t″ are sampled from a distribution [symbol] over a pre-defined set of candidate graph transformations. In the present example, edge dropout and edge feature masking are applied in the transformation pipeline.

In the present example, encoding model g_{θ} is an Attention-based Message-Passing (AMP) neural network. It produces node embeddings H′ and H″ for the views [symbol] ′ and [symbol] ″ of the input graphs [symbol] ᵢ,.

The decoding head d_{γ} for self-supervised learning can include a node-level predictor p_{ϕ} that outputs the final representations Z′ and Z″, where Z=(H). In order to learn useful representations, a regularization-based SSL loss function such as the following can be minimized:

[symbol]

^{SSL}=λ_{S}(Z′, Z″)+μ[ν(Z′)+ν(Z″)]+ν[c(Z′)+c(Z″)].

In this loss function, the weights λ, μ, and ν control the emphasis placed on each of three regularization terms. The invariance term s encourages representations of the two views to be similar. The variance term v is included to prevent the well-known collapse problem. The covariance term c promotes maximization of the information content of the representations. Following the pre-training stage, the SSL decoder is replaced with a task-specific downstream decoder d o that is trained on top of the frozen pre-trained encoder.

As noted above, two possible tasks for the disclosed solution are FLP and DNC. In FLP, the goal is to predict the probability of future edges occurring given the source, destination, and timestamp. For each positive edge, a negative edge is sampled that the model is trained to predict as negative. The DNC task involves predicting the label of the source node of a future interaction. Both tasks can be trained using binary cross entropy loss.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of any publications identified in this disclosure are incorporated herein by reference in their entirety.

1. A method of operating a computer system to process a continuous-time dynamic graph (CTDG) to perform a specific prediction task, the CTDG comprising a data structure that represents nodes and edges having temporal properties, the edges representing relationships between the nodes, the method comprising:
extracting a time window of data from the CTDG to obtain a history graph that represents a sub-set of the CTDG;
generating, using an encoder model configured by a set of learned encoder parameters and implemented by the computer system, a set of embeddings for the history graph; and
predicting, using a first decoder model configured by a first set of learned decoder parameters and implemented by the computer system, one or more predictions for the CTDG corresponding to the specific prediction task.

2. The method of claim 1 comprising configuring the computer system to perform the specific prediction task, comprising:
pre-training the encoder model using self-supervised learning to perform a generalized prediction task by:
partitioning the CTDG into a first batch of first disjoint graphs that each correspond to a respective time window of a first defined size;
performing a random transformation on each of the first disjoint graphs to generate, for each first disjoint graph, a respective pair of transformed graphs; and
iteratively, until a pre-training criteria is reached: (i) generating, using the encoder model, respective embeddings for each transformed graph in each pair of transformed graphs; (ii) generating, for each of the respective embeddings, a respective prediction, using a second decoder model that is configured by a set of second decoder parameters; and (iii) updating the encoder parameters and the second decoder parameters based on the respective predictions; and
training the encoder model and the first decoder model to collectively perform the specific prediction task by:
partitioning the CTDG into a second batch of second disjoint graphs that each correspond to a respective time window of a second defined size; and
iteratively, until a training criteria is reached: (i) generating, using the encoder model, respective embeddings for each of the second disjoint graphs; (ii) generating, for each of the respective embeddings of the second disjoint graphs, a respective task specific prediction, using the first decoder model; and (iii) updating at the first decoder parameters based on a comparison of the respective task prediction to actual data included in the CTDG.

3. The method of claim 2 wherein, during the pre-training, updating the encoder parameters and the second decoder parameters based on the respective predictions comprises comparing, for each pair of transformed graphs, the respective predictions made therefore.

4. The method of claim 2 wherein during training the encoder model and the first decoder model to collectively perform the specific prediction task, the encoder parameters are frozen and only the first decoder parameters are updated.

5. The method of claim 2 wherein the first defined size and the second defined size are hyperparameters.

6. The method of claim 2 wherein performing the random transformation on each of the first disjoint graphs comprises randomly performing edge dropouts and edge feature masking.

7. The method of claim 2 wherein the encoder model is an attention-based Message-Passing (AMP) neural network.

8. The method of claim 7 wherein the first decoder model and second decoder model comprise respective multi-layer perception neural networks.

9. The method of claim 1 wherein the specific prediction task is predicting a probability of an edge between two nodes of the CTDG at a future time, the method comprising outputting the prediction.

10. The method of claim 1 wherein the specific prediction task is predicting node classifications for one or more nodes of the CTDG at a future time, the method comprising outputting the predicted node classifications.

11. A system for processing a continuous-time dynamic graph (CTDG) to perform a specific prediction task, the CTDG comprising a data structure that represents nodes and edges having temporal properties, the edges representing relationships between the nodes, the system comprising one or more processing devices and one or more memories, and being configured to:
extract a time window of data from the CTDG to obtain a history graph that represents a sub-set of the CTDG;
generate, using an encoder model configured by a set of learned encoder parameters and implemented by the computer system, a set of embeddings for the history graph; and
predict, using a first decoder model configured by a first set of learned decoder parameters and implemented by the computer system, one or more pre-dictions for the CTDG corresponding to the specific prediction task.

12. The system of claim 11, the system being configured to pre-train the encoder model using self-supervised learning to perform a generalized prediction task by:
partitioning the CTDG into a first batch of first disjoint graphs that each correspond to a respective time window of a first defined size;
performing a random transformation on each of the first disjoint graphs to generate, for each first disjoint graph, a respective pair of trans-formed graphs; and
iteratively, until a pre-training criteria is reached: (i) generating, using the encoder model, respective embeddings for each transformed graph in each pair of transformed graphs; (ii) generating, for each of the respective embeddings, a respective prediction, using a second decoder model that is configured by a set of second decoder parameters; and (iii) updating the encoder parameters and the second decoder parameters based on the respective predictions; and
train the encoder model and the first decoder model to collectively perform the specific prediction task by:
partitioning the CTDG into a second batch of second disjoint graphs that each correspond to a respective time window of a second defined size; and
iteratively, until a training criteria is reached: (i) generating, using the encoder model, respective embeddings for each of the second disjoint graphs;
(ii) generating, for each of the respective embeddings of the second disjoint graphs, a respective task specific prediction, using the first de-coder model;
and (iii) updating at the first decoder parameters based on a comparison of the respective task prediction to actual data included in the CTDG.

13. The system of claim 12 wherein, during the pre-training, updating the encoder parameters and the second decoder parameters based on the respective predictions comprises comparing, for each pair of transformed graphs, the respective predictions made therefore.

14. The system of claim 12 wherein during training the encoder model and the first decoder model to collectively perform the specific prediction task, the encoder parameters are frozen and only the first decoder parameters are updated.

15. The system of claim 12 wherein the first defined size and the second defined size are hyperparameters.

16. The system of claim 12 wherein performing the random transformation on each of the first disjoint graphs comprises randomly performing edge dropouts and edge feature masking.

17. The system of claim 11 wherein the encoder model is an attention-based Message-Passing (AMP) neural network and the first decoder model and second decoder model comprise respective multi-layer perception neural networks.

18. The system of claim 11 wherein the specific prediction task is predicting a probability of an edge between two nodes of the CTDG at a future time, the system comprising outputting the prediction.

19. The system of claim 11 wherein the specific prediction task is predicting node classifications for one or more nodes of the CTDG at a future time, the system comprising outputting the predicted node classifications.

20. A computer program product storing non-transient instructions for configuring a computer system to process a continuous-time dynamic graph (CTDG) to perform a specific prediction task, the CTDG comprising a data structure that represents nodes and edges having temporal properties, the edges representing relationships between the nodes, the processing comprising:
extracting a time window of data from the CTDG to obtain a history graph that represents a sub-set of the CTDG;
generating, using an encoder model configured by a set of learned encoder parameters and implemented by the computer system, a set of embeddings for the history graph; and
predicting, using a first decoder model configured by a first set of learned decoder parameters and implemented by the computer system, one or more predictions for the CTDG corresponding to the specific prediction task.
